(19) United States
(12) Patent Application Publication
(10) Pub. No.: US 2023/0193695 A1
(43) Pub. Date: Jun. 22, 2023

(54) ANTI-STALL AUTOMATED TRACK STEER PROPULSION

(71) Applicant: TECHNOLOGICAL RESOURCES PTY LIMITED, Melbourne (AU)

(72) Inventors: Chris Innes, Melbourne (AU); Joel Cartwright, Melbourne (AU)

(21) Appl. No.: 17/926,870

(22) PCT Filed: May 29, 2020
(86) PCT No.: PCT/AU2020/050554

§ 371 Date: Nov. 21, 2022

(51) Int. Cl. E21B 7/02; B62D 11/00; G05D 1/02; B62D 11/02; G05D 1/00

(52) U.S. Cl. CPC E21B 7/02; B62D 11/003; G05D 1/0212; B62D 11/02; G05D 1/0297; G05D 1/0022; G05D 1/0027; G08C 17/02

(57) ABSTRACT

Disclosed herein are an anti-stall control method and system for a tracked vehicle. The system includes a control module that includes a processor and a storage medium for storing computer programming code. The computer programming code defines a set of behaviour states including: a start state, a tramming state, and at least one corrective state. Each behaviour state has an associated set of behaviour controls for governing control of tracks of the vehicle. The computer programming code, executed on the processor, performs the method steps of: assigning an initial start state, wherein the tracks of the tracked vehicle are stationary; changing to the tramming state, on receipt of instructions to move the tracked vehicle, wherein tramming behaviour controls control the tracks of the tracked vehicle to operate in the same direction; and changing to a corrective states when corrective state conditions associated with that corrective state are satisfied.

### TECHNICAL FIELD

The present disclosure relates to a method and system for controlling the behaviour of tracked vehicles.

### BACKGROUND

A tracked vehicle utilises a tracked vehicle propulsion system in the form of continuous bands of treads or track plates driven by a plurality of wheels in order to move. The treads or track plates provide a much larger surface area than tyres that might otherwise be found on an equivalent vehicle. As the weight of a tracked vehicle is distributed over the relatively large surface area of the treads or tracks being used, the vehicle is able to traverse soft ground with less likelihood of damaging the ground or becoming stuck relative to an equivalent vehicle equipped with conventional tyres.

A tracked vehicle may refer to any machinery that utilises a tracked vehicle propulsion system. Such machinery may include, for example, but is not limited to, bulldozers, excavators, drill rigs, snowmobiles, tracked robots, and the like. Whilst convention tracked vehicles required a human operator, more recent tracked vehicles include autonomous vehicles.

Tracked vehicles typically operate with two parallel tracks, one track located on each side of the vehicle. The movement of tracked vehicles is often referred to as “tramming”. A tracked vehicle utilises differential steering, in which more or less torque is applied to one track than to the opposing track, in order to steer the vehicle. When equal torque is applied to each of the tracks, the tracked vehicle moves in a straight line. However, applying a difference in torque to the tracks causes the opposing tracks to move at different rates, and potentially in different directions, causing the vehicle to turn.

Tracked vehicles are prone to stalling, with evidence indicating that higher stall rates occur when an inner track has a small opposite rotation value relative to an outer track. Further, it has been found that even applying full opposite torque to opposing tracks will not always resolve a stall. Rather, it is necessary for both tracks to move in the same direction in order to prevent or minimise stalls.

In relation to autonomous drill rigs employed on mine sites, there are difficulties with having drill rigs tram accurately to a predefined hole location. Drill rigs often stop tramming before the hole location, resulting in inaccurate drilling on the mine site. The problem of autonomous drill rigs not stopping within an acceptable distance of a predefined location, such as a blast hole location, is exacerbated by uneven surfaces, as existing tramming controls assume a level surface. In some circumstances, autonomous drill rigs have failed User Acceptance Testing (UAT) as those drill rigs were stopping too far from hole locations.

On surface mines, the locations of blast holes are set out in a drill pattern. Typically, a drill pattern is a rectangular array of blast hole locations. Depending on the terrain and the number of drill rigs working on a drill pattern, the drill rigs may need to follow paths that include turns that are unachievable.

Thus, a need exists to provide an improved method and system for controlling the behaviour of tracked vehicles.

### SUMMARY

The present disclosure relates to a method and system for controlling behaviour of tracked vehicles. In particular, the present disclosure relates to behaviour-based propulsion control of tracked machinery based on a predefined set of behaviour states, with each state being associated with control behaviours.

A first aspect of the present disclosure provides a method for controlling a tracked vehicle comprising the steps of:
defining a set of behaviour states, each behaviour state having an associated set of behaviour controls for governing control of tracks of the tracked vehicle;
assigning a behaviour state based on a current operation of said tracked vehicle, wherein behaviour controls associated with said assigned behaviour state govern control of tracks of said tracked vehicle.

A second aspect of the present disclosure provides an anti-stall control system for a tracked vehicle comprising:
a control module associated with said tracked vehicle and configured to control operation of said tracked vehicle, said control module including:
   a processor; and
   a storage medium for storing computer programming code, said computer programming code defining a set of behaviour states including: a start state, a tramming state, and at least one corrective state, wherein each behaviour state has an associated set of behaviour controls for governing control of tracks of the tracked vehicle, wherein the computer programming code, when executed on said processor, performs the method steps of:
      assigning an initial start state, wherein said tracks of the tracked vehicle are stationary;
      changing to said tramming state, on receipt of instructions to move said tracked vehicle to a terminal position, wherein tramming behaviour controls associated with said tramming state control said tracks of the tracked vehicle to operate in the same direction; and
      changing to one of said corrective states when corrective state conditions associated with that corrective state are satisfied.

A third aspect of the present disclosure provides a method of controlling a tracked vehicle comprising:
defining a set of behaviour states including: a start state, a tramming state, and at least one corrective state, wherein each behaviour state has an associated set of behaviour controls for governing control of tracks of the tracked vehicle;
assigning an initial start state, wherein said tracks of the tracked vehicle are stationary;
changing to said tramming state, on receipt of instructions to move said tracked vehicle to a terminal position, wherein tramming behaviour controls associated with said tramming state control said tracks of the tracked vehicle to operate in the same direction; and
changing to one of said corrective states when corrective state conditions associated with that corrective state are satisfied.

According to another aspect, the present disclosure provides an apparatus for implementing any one of the aforementioned methods.

According to another aspect, the present disclosure provides a computer program product including a computer readable medium having recorded thereon a computer program that when executed on a processor of a computer implements any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a schematic representation of a system on which one or more embodiments of the present disclosure may be practised;

FIG. 2 is a flow diagram illustrating relationships among behaviour states for a drill rig, in accordance with one embodiment of the present disclosure; and

FIG. 3 is a schematic block diagram representation of a system that includes a general purpose computer on which one or more embodiments of the present disclosure may be practised; and

FIG. 4 is a schematic representation of tramming (Follow Path) state behaviour.

Method steps or features in the accompanying drawings that have the same reference numerals are to be considered to have the same function(s) or operation(s), unless the contrary intention is expressed or implied.

### DETAILED DESCRIPTION

The present disclosure provides a method and control system for controlling behaviour of tracked vehicles. In particular, the present disclosure relates to behaviour-based propulsion control of tracked machinery along a designated trajectory, intended to avoid and resolve track stalls.

A control system in accordance with the present disclosure utilises a state machine having a plurality of predefined behaviour states and assigns different control behaviours to each behaviour state. Different behaviour states are used during different operations of tracked vehicles, wherein each behaviour state has an associated set of behaviour controls for governing operation of the tracked vehicle. In particular, the control system and method of the present disclosure utilise at least one corrective behaviour state wherein behaviour controls associated with each corrective behaviour state are directed to improving functionality of the tracked vehicle.

Embodiments will be described herein in relation to autonomous drill rigs suitable for use in surface mining applications. However, it will be appreciated that aspects of the invention may equally be practised on other tracked vehicles. Further, some embodiments may implement a control system for human operated tracked vehicles, wherein the control system acts as a control assist function to assist human operation of the tracked vehicles.

Surface mines extract ore by blasting areas of rock. Each area that is to be blasted is called a bench. In order to blast a bench, which is generally level, a mining engineer, also referred to as a drill blast engineer, designs a blast for that bench. The designed blast takes into account many factors, including, but not limited to, access to the bench, the geology of the rock to be blasted, the drill rigs available for use, and type and quantity of explosives to be used. The mining engineer designs a drilling plan, also known as a drill pattern, which identifies locations of blast holes, hole sizes, and hole depths of the blast holes that are to be drilled by the drill rigs.

Once approved by the drill and blast engineer, the drilling plan is typically printed and handed to a team of drill operators assigned to an area of the bench to work on. It is common for two or three operator-controlled drill rigs to work contemporaneously on the same bench. The drill operators generally divide the bench area among themselves and then drill the holes in accordance with the drilling plan, by manoeuvring the drill rigs around the drill pattern to drill holes in the predefined locations of the blast holes.

Once the drill rigs have drilled the holes, the holes are then filled with explosives by an explosives team and the explosives are detonated. The amount and type of explosive used for each blast is decided by the drill and blast engineer. The rubble produced by the blast is then collected by shovels and loaded into a fleet of dump trucks, which remove the rubble from the blast site to a processing plant. The rubble is a mixture of overburden and ore and the processing plant separates the ore from the overburden.

Autonomous drill rigs perform one or more functions, based on received computer commands, without requiring input from an onboard drill operator. Such functions may include, for example, but are not limited to, tramming to a location for a next hole to be drilled, levelling the drill rig, raising or lowering a mast associated with the drill rig, or drilling a hole, without having a drill operator on board to control operation of the drill rig. Autonomous drill rigs may be conventional blast hole drill rigs that have been retrofitted with automation technology. Alternatively, autonomous drill rigs may be designed from the ground up to function autonomously.

Each autonomous drill rig is equipped with a drill module that is capable of controlling operation of one of more functions of the drill rig. The drill module is implemented using a computing device, such as a programmable logic controller or a general purpose computer programmed to function in a customised way to control one or more functions of the drill rig.

In some embodiments, a remote control centre monitors and controls multiple autonomous drill rigs at one or more sites. The remote control centre includes a drill control station operated by a drill controller. The drill control station is coupled to a control unit that is adapted to transmit information and instructions to each drill rig, via a wireless communications network.

The remote control centre controls the operation of drill rigs at one or more mine sites allocated to that remote control centre. The remote control centre is coupled to a communications network and sends information and commands via the communications network to a site controller at each mine site associated with the remote control centre. The site controller includes a wireless transmitter for transmitting wireless signals to drill rigs located at that mine site, with each drill rig being equipped with a wireless receiver.

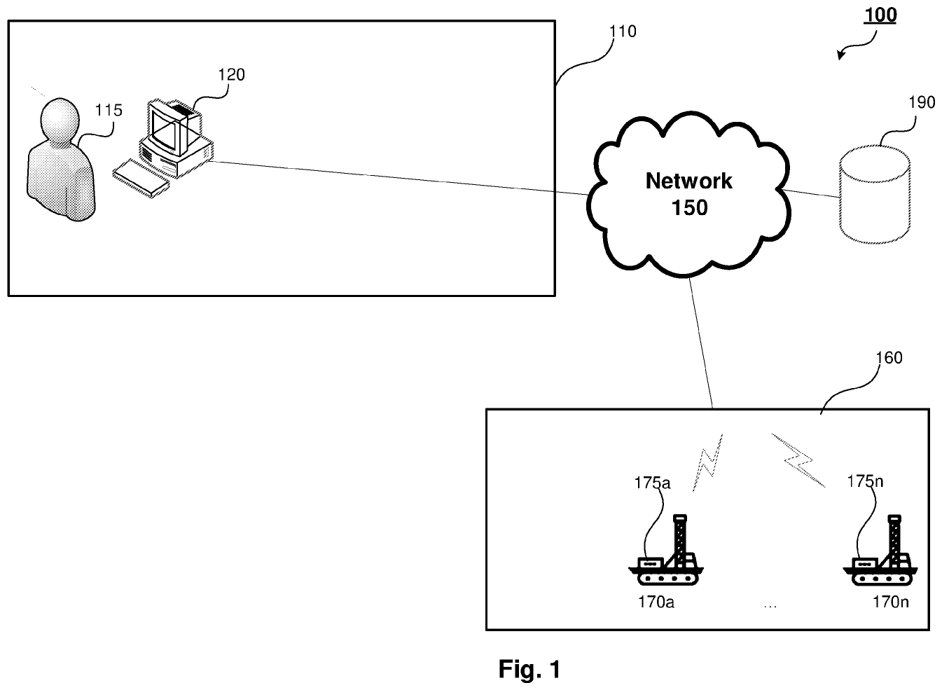

FIG. 1 is a schematic block diagram representation of a system 100 in accordance with the present disclosure. The system 100 includes a remote control centre 110 for remotely operating control of drill rigs at one or more mine sites. The remote control centre 100 includes a drill control station 120 that is accessed by a drill controller 115 to monitor and control operation of drill rigs at remotely located mine sites. Whilst the example of FIG. 1 shows a single drill control station 120, other embodiments may include multiple drill control stations to allow contemporaneous access by multiple drill controllers. Whilst the system 100 in the example of FIG. 1 shows a single mine site 160, the remote control centre 110 may be utilised to control multiple mine sites, with one or more drill rigs located at each mine site. Depending on the application, the remote control centre 110 may be co-located with the mine site 160 or alternatively may be located remotely, such as at a remotely location operations centre.

In a large installation, different drill controllers utilise a set of drill control stations to control an allocated set of drill rigs across one or more mine sites. The drill control station 120 is coupled to a communications network 150. The communications network 150 may be implemented utilising one or more wired communications links, wireless communications links, or any combination thereof. In particular, the communications network 150 may include a local area network (LAN), a wide area network (WAN), a telecommunications network, or any combination thereof. A telecommunications network may include, but is not limited to, a telephony network, such as a Public Switch Telephony Network (PSTN) or a cellular mobile telephony network, the Internet, or any combination thereof.

In the example of FIG. 1, the system 100 includes a mine site 160 that has a set of n drill rigs 170a . . . n. Each of the drill rigs 170a . . . n includes a corresponding drill control module 175a . . . n that controls operation of the respective drill rig 175a . . . n. The drill control modules 175a . . . n may be implemented using a computing device, such as a general purpose computer, a programmed logic controller, an embedded computer, or the like that is programmed to control operation of one or more functions of a drill rig, such as tramming, levelling, drilling, and the like.

Further, each of the drill rigs 170a . . . n includes a wireless transceiver for coupling the respective drill rig 170a . . . n to the communications network so as to enable communication between the drill control modules 175a . . . n and the drill control station 120.

The drill rigs 170a . . . n utilise the drill control modules 175a . . . n and the wireless transceivers to send information back to the remote control centre 110, such as information about the ground conditions, pressure on controls, and other measurement while drilling (MWD) data, such as drill bit pull down pressure and speed.

Further, each of the drill rigs 170a . . . n is capable of operating in an autonomous mode, based on instructions received from the drill control station 120. In autonomous mode, a drill rig may perform one or more functions in accordance with a drilling plan, such as tramming to a location for a next hole to be drilled, raising or lowering a mast associated with the drill rig, or drilling a hole, without having a drill operator on board to control operation of the drill rig. The drill control station 120 issues missions (e.g., a sequences of holes to be drilled autonomously, or discrete control commands for direct tele-remote control) to the drill control modules 175a . . . n to have the respective drill rigs 170a . . . n drill the sequence of hole or perform the discrete commands. Depending on the missions, instructions sent from the drill control station 120 may apply to all a single drill rigs, a set of drill rigs, or all of the drill rigs 170a . . . n.

The example of FIG. 1 also shows an optional configuration database 190, which can be used to store data relating to the configuration of each mine site 160 in relation to drill rigs operating at the mine site 160 and any associated operating parameters. In particular, the configuration database 190 can be used to store drill patterns that lay out the locations of blast holes to be drilled in a region of the mine site 160, as well as drilling production, activity, and production time accounting data.

The drill control station 120 provides the drill controller 115 with a user interface by which the drill controller 115 is able to monitor operation of the drills 170a . . . n and send commands to the drill rigs 170a . . . n. The drill controller 115 is able to access the drill control station 120 to send information and commands, via the communications network 150, to one or more of the drill rigs 170a . . . n at the mine site 160. The information and commands may relate, for example, to a drilling plan. Thus, the drill controller 115 is able to utilise the drill control station 120 to prepare and allocate tasks to each of the autonomous drill rigs 170a . . . n.

While the drill controller 115 is able to monitor and control each of the autonomous drill rigs 170a . . . n from a remote location, the drill controller 115 may be assisted by an on-site drill patroller located at the mine site 160. The drill patroller can perform on site visual inspections of the drill rigs 170a . . . n and the mine site itself and inform the drill controller 115 of any issues.

Each drill control module 175a . . . n is adapted to control behaviour of the corresponding drill rig 170a . . . n in accordance with one of a set of predefined behaviour states. Each behaviour state is associated with a set of control behaviours. The set of behaviour controls associated with a behaviour state are designed to optimise functionality of the drill rig for each of the predefined behaviour states.

During operation on a mine site, the drill control module on a drill rig determines a behaviour state for a given time while autonomous operations are in progress. In some circumstances, external events may cause a change in the behaviour state, such as intervention by a drill controller utilising a drill control station to interact with the drill rig remotely or to interrupt or stop a currently executing autonomous operation.

In some embodiments, the drill control module implements a blending of track controls between different behaviour states, in order to ensure smooth control transitions and predictable behaviour of the drill rig under control.

In one example, a set of predefined behaviour states includes:
Start
Follow Path
Terminal Approach
Fast Turn
Anti-Stall
Match Collar
Match Angle
End

The Follow Path, Terminal Approach, Fast Turn, and Anti-Stall states are behaviour states that control tracks of a drill rig during tramming in order to mitigate stalling. The Terminal Approach, Match Collar, and Match Angle are behaviour states that relate to tramming in order to improve hole accuracy. Each of said Terminal Approach, Fast Turn, Anti-Stall, Match Collar, and Match Angle states may be referred to as corrective states, as behavioural controls associated with each of those states are configured to improving functionality of the drill rig.

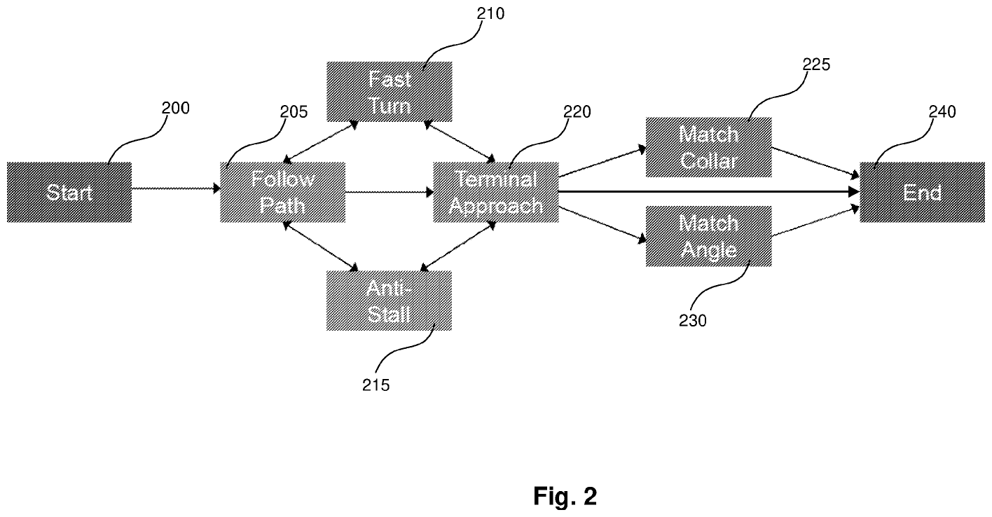

The relationships among the behaviour states in this example are depicted in FIG. 2. The default starting behaviour state is Start 200, which is linked directly to Follow Path 200. When an autonomous drill rig is tramming on a mine site, there is a risk of the drill rig stalling. In this example, the Follow Path 200 state has an associated behaviour control that controls tracks of the drill rig to operate only in the same direction. Operating the tracks of a drill rig in the same direction minimises the risk of stalling. The Follow Path 200 state uses a yaw control based on a virtual “carrot” (i.e., a reference point, virtual target, look-ahead point, or driving point) projected in front of a planned path of the drill rig.

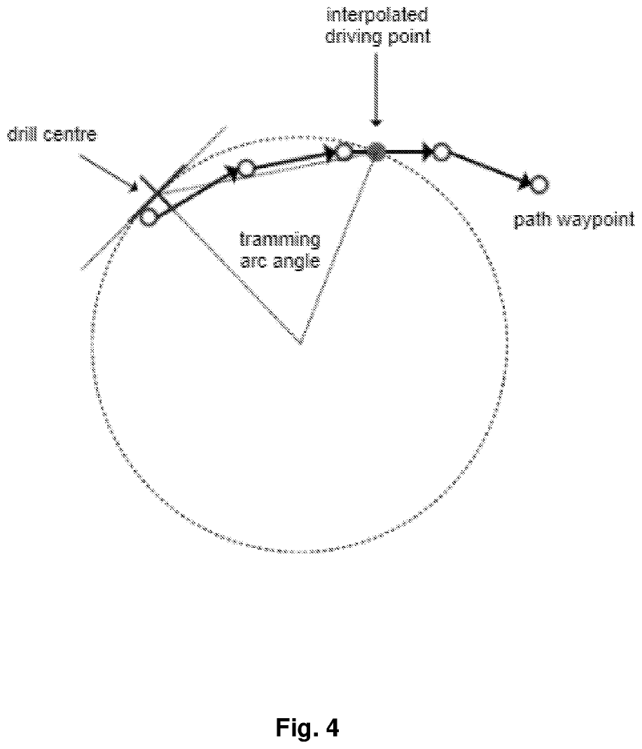

FIG. 4 illustrates the Follow Path state behaviour, which uses the following steps:
1. Map a fixed length of the planned path near the drill rig into the frame relative to the drill rig's centre of rotation and heading, including up to one waypoint back along the path;
2. When the distance to the end of the path is less than the intended relative path length, waypoints are appended using the final waypoint yaw and average path waypoint spacing;
3. Calculate a driving point (i.e., the virtual “carrot” position) by tracing along the relative path for the lookahead distance, interpolating in a straight line between waypoints.

In one embodiment, the virtual carrot is positioned 2 metres in front of the drill rig along the planned path. The actual positioning of the virtual carrot is a tuned parameter and it will be appreciated that other distances may equally be practised for different implementations. The positioning is dependent on other tuning parameters, as well as the actual system dynamics in order to achieve the desired system behaviour. The aim is to ensure as smooth control of the drill rig given the dynamic constraints, while ensuring the vehicle accurately tracks the planned path.

In general, if the value is set too low (e.g., below the actual linear velocity of the drill rig), it will result in unstable behaviour such as large control oscillations. Conversely, if the value is set too high, it will result in poor path tracking and corner cutting, but typically provide smoother control application.

Typically, it is necessary to tune a variety of parameters that are dependent on each other and impact the value chosen for the carrot position. For example, such parameters ay include PID controller values (which impact how system response times and how long it takes to correct any error) and limits on track control differentials (which limit turning radius of drill rig and is tuned to prevent controls which could induced stalling).

Monitoring of the yaw may be performed in a number of ways, including GPS tracking, track or gearbox encoders sensing track motion, or inertial measurement.

From the Follow Path 200 state, the drill control module can change state to one of the following states: Fast Turn 210, Anti-Stall 215, or Terminal Approach 220. When operating in the Follow Path 200 state, the drill control module changes state to Terminal Approach 220 when the drill rig is a predefined tramming distance from an end of a current tramming path, which may be referred to as a terminal. In one implementation, the drill control module changes state from the Follow Path 200 state to the Terminal Approach 220 state when the drill rig is 2 metres from a terminal. The end of a tramming path may include, for example, a location of a next blast hole to be drilled, such that the tramming path is the path between the previous blast hole that was drilled by the drill rig and the next blast hole on a drilling pattern to be drilled and the terminal is the location of the next blast hole.

From either the Follow Path 200 state or the Terminal Approach 220 state, if the drill control module determines that a “turn error ratio” exceeds a predefined turn error ration limit for a predefined time period, the drill control module changes behaviour state to Fast Turn 210. When the turn error ratio exceeds the predefined turn error ratio limit, it is an indication that the drill rig is attempting to turn, but is not achieving the desired turn, and thus there is a risk of the drill rig stalling or even tipping. In order to determine the “turn error ratio”, the drill control module looks at a control output from a PID controller that takes yaw error as an input. The drill control module uses the output of the PID controller (referred to herein as the yaw component) and calculates an absolute ratio between the yaw component vs a desired linear speed of the path (the linear component).

The ratio between the two is checked (i.e., yaw component/linear component). If that ratio is above a configurable limit (i.e., the predefined yaw threshold) for a configurable amount of time, the drill control module triggers a transition to the Fast Turn 210 behaviour state.

The Fast Turn 210 state controls tracks of the drill rig to reduce the yaw error to an acceptable level, being below the predefined turn error ratio limit. That is, the exit condition to leave the Fast Turn 210 state is whether the ratio between the yaw component and the linear component is below the predefined turn error ratio limit. Depending on the implementation, the turn error ratio limit is a predefined number or alternatively is user configurable. In some embodiments, the Fast Turn 210 state is associated with a minimum and maximum time for which the Fast Turn 210 state may be active. In one example, the minimum time is 0 seconds and the maximum time is 5 seconds. Different minimum and maximum times may be used, depending on the particular application. Once the maximum time is reached, the state machine transitions from the Fast Turn 210 state to a preceding behaviour state.

In some embodiments, the Fast Turn 210 state has associated behaviour controls that apply opposing propel controls to tracks on opposing sides of the drill rig in order to perform a course correcting turn. In some embodiments, control returns from Fast Turn 210 to a previous state once the yaw error no longer exceeds the predefined yaw error threshold. In some embodiments, control returns from Fast Turn 210 to a previous state only once the yaw error has not exceeded the predefined yaw error threshold for a predefined stability period. In some embodiments, control returns from Fast Turn 210 to a previous state after a predefined Fast Turn maximum time limit has been reached.

From either the Follow Path 200 state or the Terminal Approach 220 state, if the drill control module determines that either the position of the drill rig has not moved beyond a predefined position limit or the drill rig yaw has not changed beyond a predefined yaw change limit during a predefined anti-stall period, the drill control module changes the behaviour state from Follow Path 200 to Anti-Stall 215. Anti-Stall 215 has associated behaviour controls that command both tracks of the drill rig to move at full speed in the direction of a present tramming path. Once the drill rig has moved a distance greater than a predefined anti-stall distance or a predefined anti-stall time threshold has passed, the behaviour state returns from Anti-Stall 215 to a previous behaviour state.

The Terminal Approach 220 state uses an estimate of post-level ground intersection as an endpoint of a tramming run. The aim is to stop the drill rig at the position where, at the completion of levelling, there is minimal error between where the drill string intercepts the ground and the desired position (i.e., the terminal position). In order to achieve the minimal error, the Terminal Approach 220 state imposes a maximum distance the drill can travel beyond the terminal position.

In the Terminal Approach 220 state, the drill control module executes an algorithm continuously to estimate a position at which the drill string will intercept the ground once the drill rig is level. When the hole to be drilled is an angle hole, the algorithm also takes into account the terminal target yaw. The drill control module uses the estimate of the position at which the drill string will intercept the ground to adjust the distance the drill rig needs to stop by comparing this estimate against the target terminal.

The Terminal Approach 220 state can adapt to local ground conditions, with maximum benefit on angle holes. The Terminal Approach 220 state still honours authorised face approach distance. Drill patterns can have holes placed very close to open faces having steep drops. To safely manage the approach of autonomous drills to these holes, the drill control module requests authorisation from a drill operator prior to approaching these holes. The operator will designate if the hole is safe to tram. In this instance, it is desirable to prevent the drill rig from attempting to tram beyond the terminal (this is the point the operator authorises, if safe), even if the drill control module determines that is required to minimise the post-level ground intercept to terminal position error.

The Terminal Approach 220 state prevents tramming past the terminal position for such holes by limiting the ability for the terminal approach state to issue commands that would propel the drill rig beyond the terminal position. In particular, the drill control module takes a vector normal to the face and calculates a vector from the drill rig position to the terminal. The drill control module then utilises the dot product of these vectors in the path direction to calculate the allowed distance. This allowed distance is then used as a criterion to stop the drill rig as the drill rig approaches the terminal. For example, if the distance is <0.1 m, then stop all tramming commands and proceed directly to an End 240 state. In this scenario, if the drill rig overshoots the target, the distance is a negative value. In the particular example here, the preference is to minimise manoeuvring of the drill in the face zone over hole accuracy improvements achieved by the controls applied either the Match Collar 225 state or Match Angle state 230, so control passes directly from the Terminal Approach 220 state to the End 240 state.

From the Terminal Approach 220 state, the behaviour state may change to either the Fast Turn 210 or Anti-Stall 215 states, in accordance with the conditions described above and when the drill rig is located more than a predefined terminal approach distance from a blast hole location and the drill rig is not located in the face zone of a mine site bench. The face zone is a zone within a predefined distance of a face of a wall of a mine. In one example, the predefined terminal approach distance is 1.5 metres. When the drill rig is in the Terminal Approach 220 state, the associated behaviour controls ensure that the drill control module controls tramming speed of the drill rig such that the drill rig has a gradual speed deceleration. Controlling the speed in a gradual deceleration minimises any “kick” of the drill rig when stopping at the terminal. The Terminal Approach 220 state smoothly pulses speed of the drill rig when close to a desired stopping position.

From the Terminal Approach 220, when the drill rig is concerned with hole accuracy, rather than stalling during tramming operations, the behaviour state may also change to either a Match Collar 225 state or a Match Angle 230 state. In each of the Match Collar 225 and Match Angle 230 states, when the drill rig is not in the face zone of a bench, the drill control module applies opposite propel controls to correct lateral hole position or angle and smooth pulses turn speed when a required correction is small. When the drill rig is to drill a vertical hole, the Match Collar 225 state minimises the collar position error. When the drill rig is to drill an angled hole or face authorisation point, the Match Angle 230 state minimises both the angle and collar position error. Once the Match Collar 225 state and Match Angle 230 state conclude, control passes to an End 240 state.

In the Follow Path 205 and Terminal Approach 220 states, a PID controller is used to minimise the yaw error to the current “carrot” target point. The PID controller calculates a desired yaw rate control output, which is transformed into track outputs. When steering, the algorithm aims to achieve the desired yaw rate first, then with remaining track output, fulfil the linear speed requirement, if possible.

The distance to the final terminal is set by calculating the error from the current estimated post level ground intersection position (collar point) point to the final terminal position given the current drill rig yaw. This also takes into account the final turn required, given the current yaw, to ensure the drill rig can do a final turn onto the hole.

In the Match Collar 225 state, once the drill rig reaches a configured distance threshold, where the distance is the distance to the terminal calculated as described above, the drill control module turns the drill rig to minimise the lateral error to the final terminal. In the Match Angle 230 state, where the final terminal has a yaw constraint, the drill control module minimises the smaller of the two errors (the lateral error or the final terminal yaw error). If the errors are of opposite signs (i.e., minimising one will increase the other), then no adjustment is performed.

The control system described herein provides state-based control of a tracked vehicle by assigning different control behaviours to each behaviour state, wherein the control behaviours define operating conditions for tracks of the tracked vehicle.

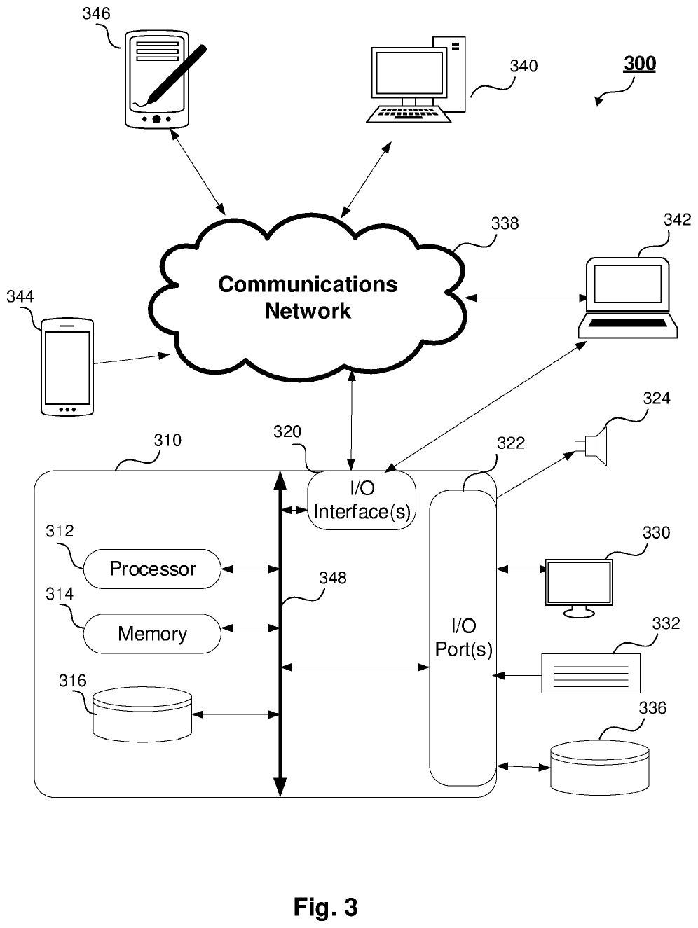

The control system of the present disclosure may be practised using one or more computing devices, such as a programmable logic controller, general purpose computer or computer server programmed and adapted to function in an improved manner. FIG. 3 is a schematic block diagram representation of a system 300 that includes a general purpose computer 310 that may be utilised to implement the control system. The general purpose computer 310 includes a plurality of components, including: a processor 312, a memory 314, a storage medium 316, input/output (I/O) interfaces 320, and input/output (I/O) ports 322. Components of the general purpose computer 310 generally communicate with each other using one or more buses 348.

The memory 314 may be implemented using Random Access Memory (RAM), Read Only Memory (ROM), or a combination thereof. The storage medium 316 may be implemented as one or more of a hard disk drive, a solid state “flash” drive, an optical disk drive, or other storage means. The storage medium 316 may be utilised to store one or more computer programs, including an operating system, software applications, and data. In one mode of operation, instructions from one or more computer programs stored in the storage medium 316 are loaded into the memory 314 via the bus 348. Instructions loaded into the memory 314 are then made available via the bus 348 or other means for execution by the processor 312 to implement a mode of operation in accordance with the executed instructions.

One or more peripheral devices may be coupled to the general purpose computer 310 via the I/O ports 322. In the example of FIG. 3, the general purpose computer 310 is coupled to each of a speaker 324, a display device 330, an input device 332, and an external storage medium 336. The speaker 324 may be implemented using one or more speakers, internal to the computing device 310 or external to the computing device 310, such as in a stereo or surround sound system. In the example in which the general purpose computer 310 is utilised to implement a control system in accordance with FIG. 1 or FIG. 2, one or more peripheral devices may relate to a speaker that issues a tone when changing from one behaviour state to another.

The display device 330 may be a computer monitor, such as a cathode ray tube screen, plasma screen, or liquid crystal display (LCD) screen. The display 330 may receive information from the computer 310 in a conventional manner, wherein the information is presented on the display device 330 for viewing by a user. The display device 330 may optionally be implemented using a touch screen to enable a user to provide input to the general purpose computer 310. The touch screen may be, for example, a capacitive touch screen, a resistive touchscreen, a surface acoustic wave touchscreen, or the like. In the example in which the general purpose computer 310 is utilised to implement the drill control station 120 of FIG. 1, the display device 310 may display a user interface for receiving inputs from the drill controller 115 and displaying information relating to the operation and control of the drill rigs 170a . . . n. Further, in the example in which the general purpose computer 310 is utilised to implement the drill control module 175a . . . n, the display 310 may be an onboard display for displaying a current behaviour state or tracking parameters.

The input device 332 may be a keyboard, a mouse, a stylus, drawing tablet, or any combination thereof, for receiving input from a user. The external storage medium 336 may include an external hard disk drive (HDD), an optical drive, a floppy disk drive, a flash drive, solid state drive (SSD), or any combination thereof and may be implemented as a single instance or multiple instances of any one or more of those devices. For example, the external storage medium 336 may be implemented as an array of hard disk drives.

The I/O interfaces 320 facilitate the exchange of information between the general purpose computing device 310 and other computing devices. The I/O interfaces may be implemented using an internal or external modem, an Ethernet connection, or the like, to enable coupling to a transmission medium. In the example of FIG. 3, the I/O interfaces 322 are coupled to a communications network 338 and directly to a computing device 342. The computing device 342 is shown as a personal computer, but may be equally be practised using a smartphone, laptop, or a tablet device. Direct communication between the general purpose computer 310 and the computing device 342 may be implemented using a wireless or wired transmission link.

The communications network 338 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 310 is able to communicate via the communications network 338 to other computing devices connected to the communications network 338, such as the mobile telephone handset 344, the touchscreen smartphone 346, the personal computer 340, and the computing device 342.

One or more instances of the general purpose computer 310 may be utilised to implement a drill control station, site controller, remote centre controller, or drill control module in accordance with the present disclosure. In such an embodiment, the memory 314 and storage 316 are utilised to store data relating to the configuration of drills at one or more mine sites, the set of predefined behaviour states and behaviour controls associated with each behaviour state. Software for implementing the control system is stored in one or both of the memory 314 and storage 316 for execution on the processor 312. The software includes computer program code for implementing method steps in accordance with the method of controlling tracked vehicles described herein.

### INDUSTRIAL APPLICABILITY

The arrangements described are applicable to the mining industry.

Although the invention has been described with reference to specific examples, it will be appreciated by those skilled in the art that the invention may be embodied in many other forms. The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Reference throughout this specification to “one embodiment,” “an embodiment,” “some embodiments,” or “embodiments” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

While some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practised without these specific details. In other instances, well-known methods, structures and techniques have not been shown in detail in order not to obscure an understanding of this description.

Note that when a method is described that includes several elements, e.g., several steps, no ordering of such elements, e.g., of such steps is implied, unless specifically stated.

The term “coupled” should not be interpreted as being limitative to direct connections only. The terms “coupled” and “connected,” along with their derivatives, may be used. It should be understood that these terms are not intended as synonyms for each other, but may be. Thus, the scope of the expression “a device A coupled to a device B” should not be limited to devices or systems wherein an input or output of device A is directly connected to an output or input of device B. It means that there exists a path between device A and device B which may be a path including other devices or means in between. Furthermore, “coupled to” does not imply direction. Hence, the expression “a device A is coupled to a device B” may be synonymous with the expression “a device B is coupled to a device A”. “Coupled” may mean that two or more elements are either in direct physical or electrical contact, or that two or more elements are not in direct contact with each other but yet still co-operate or interact with each other.

1. A method for controlling a tracked vehicle comprising the steps of:
defining a set of behaviour states, each behaviour state having an associated set of behaviour controls for governing control of tracks of the tracked vehicle;
assigning a behaviour state based on a current operation of said tracked vehicle, wherein behaviour controls associated with said assigned behaviour state govern control of tracks of said tracked vehicle.

2. The method according to claim 1, wherein said set of behaviour states includes a Follow Path state having associated behaviour controls that operate the tracks of the tracked vehicle in the same direction.

3. The method according to claim 1, wherein said set of behaviour states includes a Fast Turn state having associated behaviour controls that operate the tracks of the tracked vehicle in opposing directions.

4. The method according to claim 1, wherein said set of behaviour states includes an Anti-Stall state having associated behaviour controls that operate the tracks of the tracked vehicle at full speed in a direction of a present tramming path of said tracked vehicle.

5. The method according to claim 4, comprising the further step of:,
changing to said Anti-Stall state, when either a position of said tracked vehicle has not moved beyond a predefined position limit or a tracked vehicle yaw has not changed beyond a predefined yaw change limit during a predefined anti-stall period, wherein Anti-Stall state behaviours associated with said Anti-Stall state command all tracks of said tracked vehicle to move at full speed in the direction of a present tramming path.

6. The method according to claim 1, wherein said set of behaviour states includes a Terminal Approach state having associated behaviour controls that operate the tracks of the tracked vehicle to decelerate speed of the tracked vehicle in a gradual manner.

7. The method according to claim 1, wherein said set of behaviour states includes a Match Collar state having associated behaviour controls that minimise collar position error.

8. The method according to claim 1, wherein said set of behaviour states includes a Match Angle state having associated behaviour controls that minimise angle and collar position error.

9. The method according to claim 1, wherein said tracked vehicle is a drill rig.

10. The method according to claim 9, wherein said drill rig is equipped with a drill control module programmed to assign said behaviour state based on a current operation of said tracked vehicle and apply behaviour controls associated with said assigned behaviour state to operation of said drill rig.

11. An anti-stall control system for a tracked vehicle comprising:
a control module associated with said tracked vehicle and configured to control operation of said tracked vehicle, said control module including:
a processor; and
a storage medium for storing computer programming code, said computer programming code defining a set of behaviour states including: a start state, a tramming state, and at least one corrective state, wherein each behaviour state has an associated set of behaviour controls for governing control of tracks of the tracked vehicle, wherein the computer programming code, when executed on said processor, performs the method steps of:
assigning an initial start state, wherein said tracks of the tracked vehicle are stationary;
changing to said tramming state, on receipt of instructions to move said tracked vehicle to a terminal position, wherein tramming behaviour controls associated with said tramming state control said tracks of the tracked vehicle to operate in the same direction; and
changing to one of said corrective states when corrective state conditions associated with that corrective state are satisfied.

12. The anti-stall control system of claim 11, wherein one of said corrective states is a terminal approach state, and said computer programming code, when executing on said processor, performs the further steps of:
changing to a terminal approach state when said tracked vehicle is a predefined tramming distance from said terminal position, wherein terminal approach state behaviour controls associated with said terminal approach state utilise an estimate of post-levelling ground intersection as an endpoint of a tramming run.

13. The anti-stall control system of claim 11, wherein one of said corrective states is a fast turn state, and said computer programming code, when executing on said processor, performs the further method step of:
changing to said fast turn state when a turn error ratio of yaw component to a desired linear speed of a tramming path exceeds a predefined turn error ratio threshold, wherein fast turn state behaviour controls apply opposing propel controls to tracks on opposing sides of said tracked vehicle.

14. The anti-stall control system of claim 13, wherein said computer programming code, when executing on said processor, performs the further method steps of:
changing to a preceding behaviour state, once said turn error ratio no longer exceeds said predefined turn error ratio.

15. The anti-stall control system of claim 11, wherein one of said corrective states is an anti-stall state, and said computer programming code, when executing on said processor, performs the further method step of:
changing to said anti-stall state, when either a position of said tracked vehicle has not moved beyond a predefined position limit or a drill rig yaw has not changed beyond a predefined yaw change limit during a predefined anti-stall period, wherein anti-stall state behaviours associated with said anti-stall state command all tracks of said tracked vehicle to move at full speed in the direction of a present tramming path.

16. The anti-stall control system of claim 11, wherein said tracked vehicle is a drill rig.

17. The anti-stall control system of claim 12, wherein said set of behaviour states further includes a match collar state, said computer programming code, when executing on said processor, performs the further method step of:
changing from said terminal approach state to said match collar state, wherein match collar behaviour controls associated with said match collar state turns a drill rig to minimise lateral error to the terminal position.

18. The anti-stall control system of claim 12, wherein said set of behaviour states further includes a match angle state, said computer programming code, when executing on said processor, performs the further method step of:
changing from said terminal approach state to said match angle state, wherein match angle behaviour controls associated with said match angle minimises at least one of lateral error or terminal yaw error based on a yaw constraint.

19. The anti-stall control system of claim 11, wherein said control module includes a wireless transceiver for coupling said tracked vehicle to a remote drill control station.

20. A method of controlling a tracked vehicle comprising:
defining a set of behaviour states including: a start state, a tramming state, and at least one corrective state, wherein each behaviour state has an associated set of behaviour controls for governing control of tracks of the tracked vehicle;
assigning an initial start state, wherein said tracks of the tracked vehicle are stationary;
changing to said tramming state, on receipt of instructions to move said tracked vehicle to a terminal position, wherein tramming behaviour controls associated with said tramming state control said tracks of the tracked vehicle to operate in the same direction; and
changing to one of said corrective states when corrective state conditions associated with that corrective state are satisfied.

21. The method of claim 20,
wherein one of said corrective states is an anti-stall state, and
further wherein said step of changing to one of said corrective states changes to said anti-stall state, when either a position of said tracked vehicle has not moved beyond a predefined position limit or a drill rig yaw has not changed beyond a predefined yaw change limit during a predefined anti-stall period, wherein anti-stall state behaviours associated with said anti-stall state command all tracks of said tracked vehicle to move at full speed in the direction of a present tramming path.
